(19) United States
(12) Patent Application Publication
(10) Pub. No.: US 2025/0147994 A1
(43) Pub. Date: May 8, 2025

(54) INFORMATION PROCESSING SYSTEM AND INFORMATION PROCESSING METHOD

(71) Applicant: Semiconductor Energy Laboratory Co., Ltd., Atsugi-shi (JP)

(72) Inventors: Naoaki TSUTSUI, Atsugi (JP); Toshiki HAMADA, Isehara (JP)

(21) Appl. No.: 18/930,010

(22) Filed: Oct. 29, 2024

(30) Foreign Application Priority Data
Nov. 2, 2023 (JP) 2023-188126

(51) Int. Cl. G06F 16/33; G06F 16/35; G06F 40/186

(52) U.S. Cl. CPC G06F 16/3344; G06F 16/353; G06F 40/186

(57) ABSTRACT

A novel information processing system that is highly convenient, useful, or reliable is provided. The information processing system includes a first component, a second component, and a third component. The first component has a function of receiving a text written in a natural language and a query for performing retrieval in design assets and transferring the text and the query to the third component, a function of providing a code, and a function of emphasizing a portion related to the code and then providing the design assets. The second component has a function of generating an intermediate code from the text in accordance with a prompt and transferring the intermediate code to the third component. The third component has a function of classifying the text into a predetermined class, generating the prompt, and transferring the prompt to the second component. The third component has a function of generating the code from the command using the received intermediate code as an argument in accordance with the syntax, and transferring the code to the first component.

### BACKGROUND OF THE INVENTION

### 1. Field of the Invention

One embodiment of the present invention relates to an information processing system and an information processing method.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display device, a light-emitting device, a power storage device, a storage device, a method of driving any of them, and a method of manufacturing any of them.

### 2. Description of the Related Art

In recent years, language models using neural networks have been actively developed, and especially large language models (LLM) have attracted attention. A large language model is a natural language processing model in which learning is performed using a massive amount of data. With a large language model, for example, a conversational model that gives an answer to a user's prompt can be achieved. In Non-Patent Document 1, generative pre-trained transformer 4 (GPT-4, registered trademark) is disclosed as a large language model, and ChatGPT is disclosed as a conversational model.

By utilizing a large language model, the capacity of a natural language processing model is significantly increased. On the other hand, it is difficult to incorporate and operate a language model at one's own facilities and expense due to the expansion of the language model. Accordingly, a language model provided by an external service is generally used.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

One object of one embodiment of the present invention is to provide a novel information processing system that is highly convenient, useful, or reliable. Another object is to provide a novel information processing method that is highly convenient, useful, or reliable. Another object is to provide a novel information processing system, a novel information processing method, or a novel semiconductor device.

Note that the description of these objects does not preclude the existence of other objects. In one embodiment of the present invention, there is no need to achieve all of these objects. Other objects will be apparent from and can be derived from the description of the specification, the drawings, the claims, and the like.

(1) One embodiment of the present invention is an information processing system including a first component, a second component, and a third component.

The first component has a function of receiving a text written in a natural language and a query for performing retrieval in design assets and transferring the text and the query to the third component. The first component has a function of providing a code and a function of emphasizing a portion related to the code and then providing the design assets.

The second component has a function of executing processing using a large language model. The second component has a function of generating an intermediate code from the text in accordance with a prompt and transferring the intermediate code to the third component.

The third component has a function of executing processing using a large language model. The third component has a function of classifying the text into a predetermined class. The third component has a function of generating the prompt and transferring the prompt to the second component when the text is classified into one class. The prompt includes the text and a template.

The third component has a function of executing processing using a first database.

The first database includes a first record. The first record includes a command, a syntax associated with the command, the template associated with the command, and the class associated with the command. The template includes a first instruction for analyzing the text and extracting predetermined information, a second instruction for converting the extracted information into the intermediate code using a conversion rule, and the conversion rule.

The first database has a function of responding to a query for specifying the class with the command, the syntax, and the template.

The third component has a function of generating the code from the command using the received intermediate code as an argument in accordance with the syntax, and transferring the code to the first component.

The third component has a function of executing processing using a second database. The second database has a function of responding to the query with the design assets. The third component has a function of transferring the design assets to the first component.

(2) Another embodiment of the present invention is the information processing system in which the query includes design specifications. The second database includes a second record. The second record includes the design assets and the design specifications associated with the design assets.

Accordingly, the user can operate software with use of a text written in a natural language. The user can operate the software even when not skilled in the operation. The user can operate the software without referring to an operation manual. The user can generate a code related to the operation with use of a text written in a natural language. The user can utilize a programming language with use of a text written in a natural language. The user can be provided with an emphasized portion related to the code that is retrieved from the design assets of a circuit. The user can refer to the design assets of the circuit. Even an inexperienced user can use a design tool made for a user with an advanced specialized knowledge. As a result, a novel information processing system that is highly convenient, useful, or reliable can be provided.

(3) Another embodiment of the present invention is the information processing system in which the second component has a function of, generating a message for requesting a supplement to the information in accordance with the prompt and transferring the message to the third component.

The third component has a function of transferring the message to the first component when receiving the message. The template includes a third instruction for generating the message when the information is not sufficiently extracted.

The first component has a function of, when receiving the message, providing the message and a function of emphasizing a portion related to the command and then providing the design assets.

(4) Another embodiment of the present invention is the information processing system in which the first component has a function of receiving a supplementary text and transferring the supplementary text to the third component.

The third component has a function of adding the supplementary text to the text, updating the prompt, and transferring the updated prompt to the second component.

Accordingly, the user can supplement and modify a text with use of a supplementary text written in a natural language. The user can supplement and modify the operation of software. The user can supplement and modify the operation of the software even when not skilled in the operation. The user can supplement and modify the operation of the software without referring to an operation manual. The user can supplement and modify a code related to the operation with use of a supplementary text written in a natural language. The user can supplement and modify the description written in a programming language with use of a supplementary text written in a natural language. The user can be provided with an emphasized portion related to the command that is retrieved from the design assets of a circuit. The user can refer to the design assets of the circuit. Even an inexperienced user can use a design tool made for a user with an advanced specialized knowledge. As a result, a novel information processing system that is highly convenient, useful, or reliable can be provided.

(5) Another embodiment of the present invention is an information processing method including a first step, a second step, a third step, a fourth step, a fifth step, a sixth step, a seventh step, and an eighth step.

In the first step, a first component receives a text and a query for performing retrieval in design assets and transfers the text and the query to a second component.

In the second step, the second component sends an inquiry to a first database using the query, obtains the design assets, and transfers the design assets to the first component.

In the third step, the second component classifies the text into a predetermined class using a large language model.

When the text is classified into the class, in the fourth step, the second component specifies the class, sends an inquiry to a second database, and obtains a command, a syntax, and a template. The second database includes a record. The record includes the command, the syntax associated with the command, the template associated with the command, and the class associated with the command.

In the fifth step, the second component generates a prompt and transfers the prompt to the third component. The prompt includes the text and the template. The template includes a first instruction for analyzing the text and extracting predetermined information, a second instruction for converting the extracted information into an intermediate code using a conversion rule, and the conversion rule.

In the sixth step, the third component generates the intermediate code from the text in accordance with the prompt using a large language model and transfers the intermediate code to the second component.

In the seventh step, the second component generates a code and transfers the code to the first component. The code includes the command using the received intermediate code as an argument in accordance with the syntax.

In the eighth step, the first component provides the code and the design assets including an emphasized portion related to the code.

Accordingly, the user can operate software with use of a text written in a natural language. The user can operate the software even when not skilled in the operation. The user can operate the software without referring to an operation manual. The user can generate a code related to the operation with use of a text written in a natural language. The user can utilize a programming language with use of a text written in a natural language. The user can be provided with an emphasized portion related to the code that is retrieved from the design assets of a circuit. The user can refer to the design assets of the circuit. Even an inexperienced user can use a design tool made for a user with an advanced specialized knowledge. As a result, a novel information processing method that is highly convenient, useful, or reliable can be provided.

(6) Another embodiment of the present invention is an information processing method including a first step, a second step, a third step, a fourth step, a fifth step, a sixth step, a seventh step, an eighth step, a ninth step, a tenth step, an eleventh step, a twelfth step, a thirteenth step, and a fourteenth step.

In the first step, a first component receives a text and a query for performing retrieval in design assets and transfers the text and the query to a second component.

In the second step, the second component sends an inquiry to a first database using the query, obtains the design assets, and transfers the design assets to the first component.

In the third step, the second component classifies the text into a predetermined class using a large language model.

When the text is classified into the class, in the fourth step, the second component specifies the class, sends an inquiry to a second database, and obtains a command, a syntax, and a template. The second database includes a record. The record includes the command, the syntax associated with the command, the template associated with the command, and the class associated with the command.

In the fifth step, the second component generates a prompt and transfers the prompt to the third component. The prompt includes the text and the template. The template includes a first instruction for analyzing the text and extracting predetermined information; a second instruction for converting the extracted information into an intermediate code using a conversion rule; the conversion rule; and a third instruction for generating a message for requesting a supplement to the information when the information is not sufficiently extracted, and transferring the message to the second component.

In the sixth step, the third component generates the intermediate code from the text in accordance with the prompt using a large language model and transfers the intermediate code to the second component.

In the seventh step, the information processing method determines to proceed to the eighth step when the information is not sufficiently extracted, and determines to proceed to the thirteenth step in the other cases.

In the eighth step, the third component generates the message for requesting a supplement to the information in accordance with the prompt and transfers the message to the second component.

In the ninth step, the second component transfers the message to the first component.

In the tenth step, the first component provides the message and the design assets including an emphasized portion related to the command and waits for input of a supplementary text.

In the eleventh step, the first component receives the supplementary text and transfers the supplementary text to the second component.

In the twelfth step, the second component adds the supplementary text to the text and updates the prompt. After the twelfth step, the sixth step is performed.

In the thirteenth step, the second component generates a code and transfers the code to the first component. The code includes the command using the received intermediate code as an argument in accordance with the syntax.

In the fourteenth step, the first component provides the code and the design assets including an emphasized portion related to the code.

Accordingly, the user can supplement and modify a text with use of a supplementary text written in a natural language. The user can supplement and modify the operation of software. The user can supplement and modify the operation of the software even when not skilled in the operation. The user can supplement and modify the operation of the software without referring to an operation manual. The user can supplement and modify a code related to the operation with use of a supplementary text written in a natural language. The user can supplement and modify the description written in a programming language with use of a supplementary text written in a natural language. The user can be provided with an emphasized portion related to the command that is retrieved from the design assets of a circuit. The user can refer to the design assets of the circuit. Even an inexperienced user can use a design tool made for a user with an advanced specialized knowledge. As a result, a novel information processing method that is highly convenient, useful, or reliable can be provided.

Although the block diagram in drawings attached to this specification shows components classified based on their functions in independent blocks, it is difficult to classify actual components based on their functions completely, and one component can have a plurality of functions.

One embodiment of the present invention can provide a novel information processing system that is highly convenient, useful, or reliable. Another embodiment of the present invention can provide a novel information processing method that is highly convenient, useful, or reliable. A novel information processing system can be provided. A novel information processing method can be provided.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

In the accompanying drawings:

FIG. 1 illustrates a structure of an information processing system of an embodiment;

FIGS. 2A and 2B illustrate a structure of an information processing system of an embodiment;

FIGS. 3A to 3C illustrate a structure of an information processing system of an embodiment;

FIG. 4 illustrates a structure of an information processing system of an embodiment;

FIGS. 5A and 5B illustrate a structure of an information processing system of an embodiment;

FIG. 6 illustrates a structure of an information processing system of an embodiment;

FIG. 7 illustrates an information processing method of an embodiment; and

FIG. 8 illustrates an information processing method of an embodiment.

### DETAILED DESCRIPTION OF THE INVENTION

An information processing system of one embodiment of the present invention includes a first component, a second component, and a third component. The first component has a function of receiving a text written in a natural language and a query for performing retrieval in design assets and transferring the text and the query to the third component. The first component has a function of providing a code and a function of emphasizing a portion related to the code and then providing the design assets. The second component has a function of executing processing using a large language model. The second component has a function of generating an intermediate code from the text in accordance with a prompt and transferring the intermediate code to the third component. The third component has a function of executing processing using a large language model. The third component has a function of classifying the text into a predetermined class. The third component has a function of generating the prompt and transferring the prompt to the second component when the text is classified into one class. The prompt includes the text and a template. The third component has a function of executing processing using a first database. The first database includes a first record. The first record includes a command, a syntax associated with the command, the template associated with the command, and the class associated with the command. The template includes a first instruction for analyzing the text and extracting predetermined information, a second instruction for converting the extracted information into the intermediate code using a conversion rule, and the conversion rule. The first database has a function of responding to a query for specifying the class with the command, the syntax, and the template. The third component has a function of generating the code from the command using the received intermediate code as an argument in accordance with the syntax, and transferring the code to the first component. The third component has a function of executing processing using a second database. The second database has a function of responding to the query with the design assets. The third component has a function of transferring the design assets to the first component.

Accordingly, the user can operate software with use of a text written in a natural language. The user can operate the software even when not skilled in the operation. The user can operate the software without referring to an operation manual. The user can generate a code related to the operation with use of a text written in a natural language. The user can utilize a programming language with use of a text written in a natural language. The user can be provided with an emphasized portion related to the code that is retrieved from the design assets of a circuit. The user can refer to the design assets of the circuit. Even an inexperienced user can use a design tool made for a user with an advanced specialized knowledge. As a result, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments. Note that in structures of the invention described below, the same portions or portions having similar functions are denoted by the same reference numerals in different drawings, and the description thereof is not repeated.

### Embodiment 1

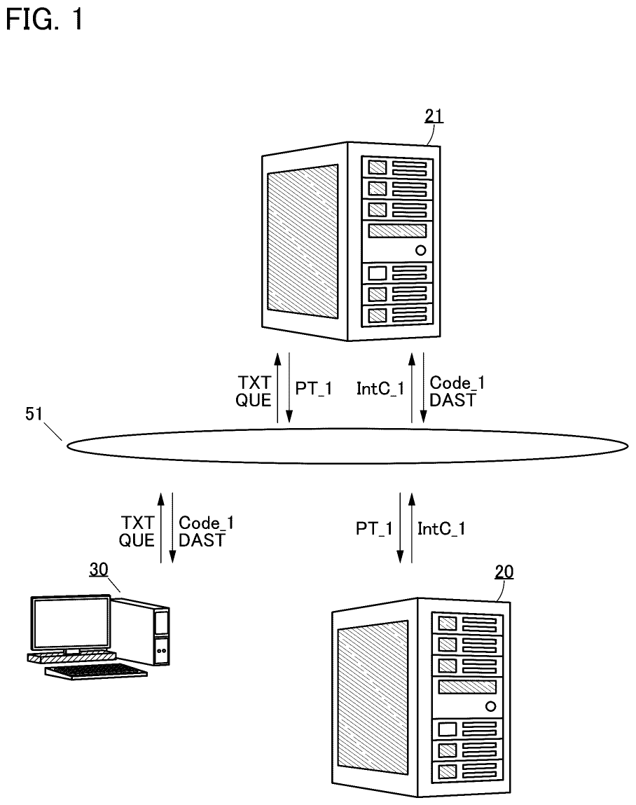

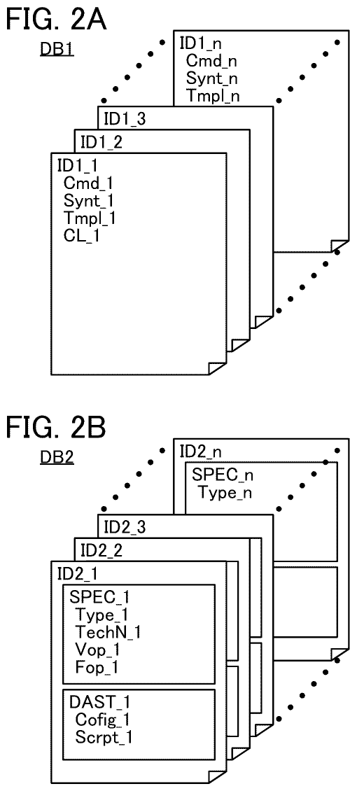

In this embodiment, an information processing system of one embodiment of the present invention is described with reference to FIG. 1, FIGS. 2A and 2B, FIGS. 3A to 3C, FIG. 4, FIGS. 5A and 5B, and FIG. 6.

FIG. 1 illustrates a structure of the information processing system of one embodiment of the present invention.

FIGS. 2A and 2B are schematic views each illustrating a structure of a database used by the information processing system of one embodiment of the present invention.

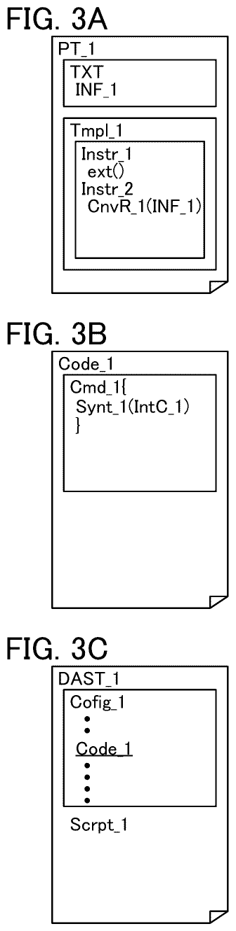

FIG. 3A is a schematic view illustrating a structure of a prompt used by the information processing system of one embodiment of the present invention. FIG. 3B is a schematic view illustrating a structure of a code generated by the information processing system of one embodiment of the present invention. FIG. 3C is a schematic view illustrating a state where the information processing system of one embodiment of the present invention provides design assets.

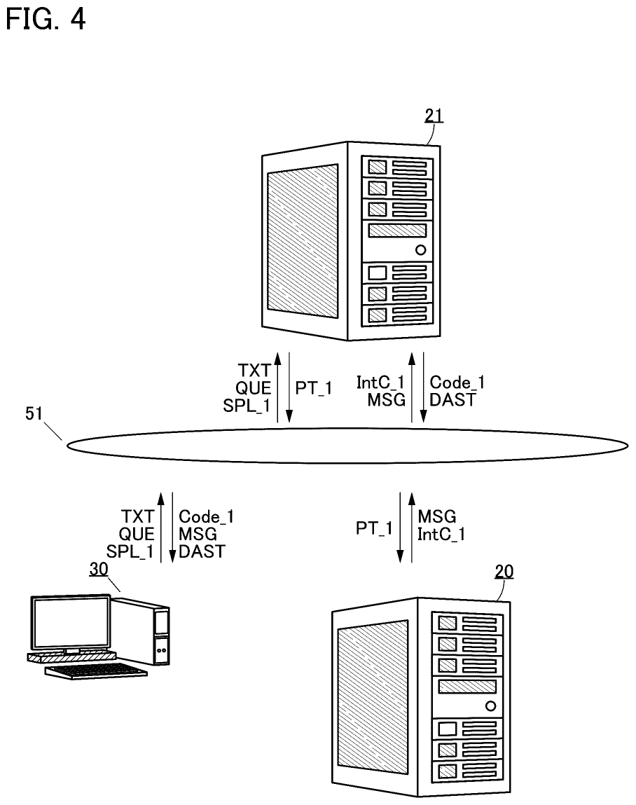

FIG. 4 is a schematic view illustrating a function of the information processing system of one embodiment of the present invention.

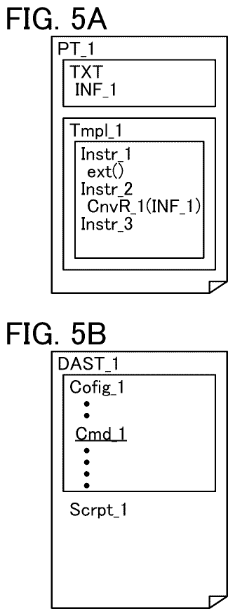

FIG. 5A is a schematic view illustrating a structure of a prompt used by the information processing system of one embodiment of the present invention. FIG. 5B is a schematic view illustrating a state where the information processing system of one embodiment of the present invention provides design assets.

### <Structure Example 1 of Information Processing System>

The information processing system described in this embodiment includes a component 30, a component 20, and a component 21 (see FIG. 1).

### <<Structure Example 1 of Component 30>>

The component 30 has a function of receiving a text TXT written in a natural language and a query QUE for performing retrieval in design assets DAST and transferring the text TXT and the query QUE to the component 21. For example, a user of the information processing system inputs the text TXT and the query QUE to the component 30. The component 30 can transfer the text TXT and the query QUE to the component 21 through a network 51 (see FIG. 1).

The component 30 has a function of providing a code denoted by Code_1 (hereinafter abbreviated to Code_1) and a function of emphasizing a portion related to the Code_1 and then providing the design assets DAST to, for example, the user of the information processing system (see FIG. 3C). Specifically, the component 30 has a function of underlining or highlighting the portion related to the Code_1 and then displaying the design assets DAST, for example.

### <<Structure Example 1 of Component 20>>

The component 20 has a function of executing processing using a large language model (LLM). For example, the component 20 can execute processing using Bidirectional Encoder Representations from Transformers (BERT), which is a language model. Alternatively, for example, the component 20 can execute processing using GPT-3, GPT-3.5, GPT-4, Language Model for Empiric Applications (LaMDA), Pathways Language Model (PaLM), Llama2, ALBERT, XLNet, or the like.

Specifically, the component 20 has a function of, in accordance with a prompt PT_1, generating an intermediate code IntC_1 from the text TXT and transferring the intermediate code IntC_1 to the component 21. The intermediate code IntC_1 can be transferred to the component 21 through the network 51, for example (see FIG. 1).

Although the details of the operation will be described later, in accordance with the prompt PT_1 exemplified in the next paragraph, the component 21 generates, from the text TXT, the following intermediate code IntC_1: “{“power_ring”: [“VDD”, “GND”], “layers”: [“M1”, “M2”], “line_width”: “5”}”.

“

Analyze the following text and convert the text in accordance with rules. The text conversion rules are as follows.

### #Conversion Rules

Rule 1. Power rings are X1, X2, and X3.=>{“power_ring”: [X1, X2, X3]}
Rule 2. Layers are X1, X2, and X3.=>{“layers”: [X1, X2, X3]}
Rule 3. The line width is X.=>{“line_width”: X}

### #Text

Create power rings of VDD and GND. Layers M1 and M2 are used. The line width is 5 μm.

”

### <<Structure Example 1 of Component 21>>

The component 21 has a function of executing processing using a large language model. The component 21 has a function of classifying the given text TXT into a predetermined class, for example.

A dictionary-type list including a set of a class and its definition is prepared, for example. Then, the dictionary-type list, a prompt “Analyze the following text and select a class whose meaning is most similar to that of the text from the dictionary-type list”, and the text TXT are supplied to the component 21. Accordingly, the text TXT can be classified into a predetermined class.

For example, it is possible to use a dictionary-type list including a set of a class CL_1 and “Place a power ring.”, a set of a class CL_2 and “Make a floor plan.”, and a set of a class CL_3 and “Make a clock tree.”.

When the component 21 is supplied with the dictionary-type list, the prompt, and the text TXT “Create power rings of VDD and GND. Layers M1 and M2 are used.”, the component 21 classifies the text TXT into the class CL_1.

With use of a prompt “Analyze the following text and select three classes in the descending order of the degree of similarity in the meaning of the text.”, a plurality of classes that are ordered by priority can be selected as candidates.

The component 21 has a function of, when the text TXT is classified into the class CL_1, generating the prompt PT_1 and transferring the prompt PT_1 to the component 20. The component 21 can transfer the prompt PT_1 to the component 20 through the network 51, for example (see FIG. 1).

### [Example of Prompt PT_1]

The prompt PT_1 includes the text TXT and a template Tmpl_1 (see FIG. 3A). Note that the template Tmpl_1 can be obtained from a database DB1 described later.

### <<Structure Example 2 of Component 21>>

The component 21 has a function of executing processing using the database DB1.

### [Structure Example 1 of Database DB1]

The database DB1 includes one or more records. For example, the database DB1 includes a record ID1_1 to a record ID1_n (see FIG. 2A).

The record ID1_1 includes a command Cmd_1 and a syntax Synt_1, the template Tmpl_1, and the class CL_1 each associated with the command Cmd_1. Note that the Code_1 provided by the information processing system of one embodiment of the present invention is written in a programming language including the command Cmd_1.

### <Command Cmd_1>

For example, “createRing” can be used as the command Cmd_1. Note that “createRing” is a command for placing a power ring. The command Cmd_1 is included in the programming language used for the Code_1 provided by the information processing system of one embodiment of the present invention.

### <Syntax Synt_1>

The command Cmd_1 is associated with the syntax Synt_1, and the command Cmd_1 is constructed in accordance with the syntax Synt_1.

For example, the command “createRing” is associated with a syntax “-net ${power_ring} -layers ${layers} -line_width ${line_width}”. Note that “-net” is an item that specifies a name of a wiring to be created as a power ring. Furthermore, “-layers” is an item that specifies a name of a layer to be used for creating the wiring, and “-line_width” is an item that specifies the line width.

### <Example 1 of Template Tmpl_1>

The template Tmpl_1 includes an instruction Instr_1 for analyzing the text TXT and extracting predetermined information INF_1, an instruction Instr_2 for converting the extracted information INF_1 into the intermediate code IntC_1 using a conversion rule CnvR_1, and the conversion rule CnvR_1 (see FIG. 3A). Note that in the drawing, ext( ) means processing for extracting predetermined information, and CnvR_1 (INF_1) means processing for converting the information INF_1 into the intermediate code IntC_1 using the conversion rule CnvR_1.

The instruction Instr_1 and the instruction Instr_2 can each be “Analyze the following text and convert the text into the JSON format in accordance with rules. The text conversion rules are as follows.”, for example.

As the conversion rule CnvR_1, the following rules can be used, for example.

“
Rule 1. Power rings are X1, X2, and X3.=>{“power_ring”: [X1, X2, X3]}
Rule 2. Layers are X1, X2, and X3.=>{“layers”: [X1, X2, X3]}
Rule 3. The line width is X.=>{“line_width”: X}

”

Note that the conversion rule CnvR_1 includes a function of specifying information on the wiring name, information on the layer, and information on the line width and extracting them. In other words, the conversion rule CnvR_1 can be used as a means for specifying the information INF_1 described in the text TXT, extracting the information INF_1 from the text TXT, and converting the information INF_1 into the intermediate code IntC_1.

In addition, data storing an item and a value corresponding to the item can be used for the intermediate code IntC_1. Any data format can be used as long as the format can store a key and a value. For example, data written in the JavaScript Object Notation (JSON) format can be used for the intermediate code IntC_1.

### <Class CL_1>

A programming language defines various “commands”. A function of each “command” can be described using a natural language. Descriptions written in a natural language can be classified using a large language model. Thus, when the description is classified into one class, a “command” corresponding to the description can be classified into the class. For example, when description related to the command Cmd_1 and written in a natural language is classified into the class CL_1 using a large language model, the command Cmd_1 can be classified into the class CL_1.

When the text TXT written in a natural language is classified into a predetermined class, the text TXT is highly likely to include a “command” classified into the class. For example, when the text TXT is classified into the class CL_1, the received text TXT is highly likely to be description related to the command Cmd_1. That is, by classifying the command Cmd_1 into the class CL_1 in advance, the received text TXT can be associated with the command Cmd_1 with use of the class CL_1 as a medium.

Note that the received text TXT can also be directly associated with the command Cmd_1. The text TXT can be associated with a predetermined command in the following manner, for example: a dictionary-type list including a set of a command and its definition is prepared, and the dictionary-type list, a prompt “Analyze the following text and select a command whose meaning is most similar to that of the text from the dictionary-type list”, and the text TXT are supplied to the component 21. Furthermore, the text TXT can be associated with a predetermined command with use of a semantic search, a vector search, or the like.

### [Structure Example 2 of Database DB]

The database DB1 has a function of responding to a query for specifying the class CL_1 with the command Cmd_1, the syntax Synt_1, and the template Tmpl_1.

### <<Structure Example 3 of Component 21>>

The component 21 has a function of generating the Code_1 from the command Cmd_1 using the received intermediate code IntC_1 as an argument in accordance with the syntax Synt_1, and transferring the Code_1 to the component 30.

For example, the component 21 processes the intermediate code IntC_1 exemplified in the next paragraph in accordance with the syntax Synt_1, whereby the intermediate code IntC_1 is converted into an argument “-net {VDD GND} -layers {M1 M2} -line_width 5”.
“{“power_ring”: [“VDD”, “GND”], “layers”: [“M1”, “M2”], “line_width”: “5”}”

The component 21 connects the command Cmd_1 and the argument to generate the Code_1 “createRing -net {VDD GND} -layers {M1 M2} -line_width 5”. Note that the Code_1 is a code for creating power rings using VDD and GND as wiring names, M1 and M2 as layers, and a line width of 5 μm.

### <<Structure Example 4 of Component 21>>

The component 21 has a function of executing processing using a database DB2 and a function of transferring the design assets DAST to the component 30.

### [Structure Example of Database DB2]

The database DB2 includes one or more records. A code created by the user of the information processing system of one embodiment of the present invention can be used for the design assets, for example. In addition, a code created in an organization where the user of the information processing system of one embodiment of the present invention belongs can be used for the design assets.

Specifically, a setting file of an electronic design automation (EDA) tool can be used for the design assets. In addition, a script file for making the EDA tool perform a predetermined operation can be used for the design assets.

The database DB2 includes a record ID2_1 to a record ID2_n (see FIG. 2B). The record ID2_1 includes the design assets DAST and design specifications SPEC_1 associated with the design assets DAST, for example. When the setting file of the EDA tool is used for the record, the record includes, for example, design specifications of a semiconductor device designed using the EDA tool. Specific examples of the design specifications include the kind of the semiconductor device, a technology node, a chip area, operating voltage, operating frequency, and bus width. Note that examples of the kind of the semiconductor device include a central arithmetic device and a storage device.

The database DB2 has a function of responding to the query QUE with the design assets DAST when the query QUE includes the design specifications SPEC_1, for example. For example, by performing retrieval in the design assets DAST while the kind of the semiconductor device, a technology node, a chip area, operating voltage, operating frequency, and bus width are specified, a code created before by the user of the information processing system can be called. In addition, a code created in an organization where the user of the information processing system belongs can be called.

Accordingly, the user can operate software with use of the text TXT written in a natural language. The user can operate the software even when not skilled in the operation. The user can operate the software without referring to an operation manual. The user can generate the Code_1 related to the operation with use of the text TXT written in a natural language. The user can utilize a programming language with use of the text TXT written in a natural language. The user can be provided with an emphasized portion related to the Code_1 that is retrieved from the design assets DAST of a circuit. The user can refer to the design assets DAST of the circuit. Even an inexperienced user can use a design tool made for a user with an advanced specialized knowledge. As a result, a novel information processing system that is highly convenient, useful, or reliable can be provided.

### <Structure Example 2 of Information Processing System>

The structure of an information processing system described in this embodiment with reference to FIG. 4 and the like is partly different from the structure of the information processing system described with reference to FIG. 1 and the like. Different portions are described in detail here, and the above description is referred to for portions having the same structure as the above.

### <<Structure Example 2 of Component 20>>

The component 20 has a function of, in accordance with the prompt PT_1, generating a message MSG for requesting a supplement to the information INF_1, and transferring the message MSG to the component 21 (see FIG. 4). For example, the component 20 can generate the message MSG for requesting compensation for missing information.

### <<Structure Example 5 of Component 21>>

The component 21 has a function of transferring the message MSG to the component 30 when receiving the message MSG.

### [Structure Example 3 of Database DB]

As the database DB1 of the component 21, a database having a structure different from that in the above-described structure example of the information processing system can be used. For example, a template having a different structure can be used as the template Tmpl_1.

### <Example 2 of Template Tmpl_1>

The template Tmpl_1 includes an instruction Instr_3 for generating the message MSG for requesting a supplement to the information INF_1 when the information INF_1 is not sufficiently extracted (see FIG. 5A).

The instruction Instr_1, the instruction Instr_2, and the instruction Instr_3 can each be “Analyze the following text and convert the text in accordance with rules. The text conversion rules are as follows. When some conversion rules are not used, generate a message for requesting compensation for missing information.”, for example.

Specifically, in the case where the information INF_1 extracted from the text TXT is lacking in information on the line width, the component 20 can be made to generate the message MSG “The line width needs to be specified.” using a large language model.

### <<Structure Example 6 of Component 21>>

The component 21 has a function of adding a supplementary text SPL_1 to the text TXT, updating the prompt PT_1, and transferring the updated prompt PT_1 to the component 20. The component 21 can transfer the updated prompt PT_1 to the component 20 through the network 51 (see FIG. 4), for example.

### <<Structure Example 2 of Component 30>>

The component 30 has a function of providing the message MSG to the user of the system when receiving the message MSG (see FIG. 4). The component 30 also has a function of emphasizing a portion related to the command Cmd_1 and then providing the design assets DAST (see FIG. 5B). The user of the system can supplement the information INF_1, for example, with reference to the portion related to the command Cmd_1 in the design assets DAST.

The component 30 has a function of receiving the supplementary text SPL_1 and transferring the supplementary text SPL_1 to the component 21. The supplementary text SPL_1 can be transferred to the component 21 through the network 51, for example (see FIG. 4).

Accordingly, the user can supplement and modify the text TXT with use of the supplementary text SPL_1 written in a natural language. The user can supplement and modify the operation of software. The user can supplement and modify the operation of the software even when not skilled in the operation. The user can supplement and modify the operation of the software without referring to an operation manual. The user can supplement and modify the Code_1 related to the operation with use of the supplementary text SPL_1 written in a natural language. The user can supplement and modify the description written in a programming language with use of the supplementary text SPL_1 written in a natural language. The user can be provided with an emphasized portion related to the command Cmd_1 that is retrieved from the design assets DAST of a circuit. The user can refer to the design assets DAST of the circuit. Even an inexperienced user can use a design tool made for a user with an advanced specialized knowledge. As a result, a novel information processing system that is highly convenient, useful, or reliable can be provided.

### <Structure Example 3 of Information Processing System>

The information processing system described in this embodiment includes the component 30, the component 20, and the component 21 (see FIG. 1 and FIG. 4).

The information processing system of one embodiment of the present invention can be composed of an information processing device having a function of the component 30, an information processing device having a function of the component 20, and an information processing device having a function of the component 21, for example. Note that the information processing system of one embodiment of the present invention includes one or more information processing devices. For another example, the information processing system of one embodiment of the present invention can be composed of a plurality of information processing devices connected to each other through the network 51.

When the information processing system of one embodiment of the present invention is composed of a plurality of information processing devices, loads relating to information processing can be dispersed.

### <<Structure Example 1 of Information Processing Device>>

A structure example 1 of the information processing device described in this embodiment can be used as the component 30. The structure example 1 of the information processing device can be referred to as a client computer or the like. For example, a desktop computer can be used as the component 30.

The structure example 1 of the information processing device can receive data input by the user of the information processing system of one embodiment of the present invention. The structure example 1 of the information processing device can provide the user with data output from the information processing system of one embodiment of the present invention.

Dedicated application software, a web browser, or the like operates, for example. The user of the information processing system of one embodiment of the present invention can access the information processing system through the dedicated application software, the web browser, or the like. Thus, the user can enjoy a service using the information processing system of one embodiment of the present invention.

### <<Structure Example 2 of Information Processing Device>>

A structure example 2 of the information processing device described in this embodiment can be used as the component 21. For example, a workstation, a server computer, or a supercomputer can be used as the component 21.

The structure example 2 of the information processing device preferably has a function as a parallel computer. When the structure example 2 of the information processing device is used as a parallel computer, large-scale computation necessary for artificial intelligence (AI) learning and inference can be performed, for example.

Furthermore, the structure example 2 of the information processing device can execute processing using a natural language processing model with AI.

For example, the structure example 2 of the information processing device can execute natural language processing, which is processing using a natural language model such as BERT, Text-to-Text Transfer Transformer (T5), GPT-3, GPT-3.5, GPT-4, LaMDA, PaLM, or Llama2.

### <<Structure Example 3 of Information Processing Device>>

A structure example 3 of the information processing device described in this embodiment can be used as the component 20, for example. Note that the component 20 has a larger scale and higher computational capability than the component 21. For example, a large computer such as a server computer or a supercomputer can be used as the component 20.

The structure example 3 of the information processing device preferably has a function as a parallel computer. When the structure example 3 of the information processing device is used as a parallel computer, large-scale computation necessary for AI learning and inference can be performed, for example.

Furthermore, the structure example 3 of the information processing device can execute processing using a natural language processing model with AI. In particular, the structure example 3 of the information processing device can execute processing using a general-purpose language processing model capable of performing a variety of natural language processing tasks.

For example, the structure example 3 of the information processing device can execute natural language processing, which is processing using a natural language model such as BERT, Text-to-Text Transfer Transformer (T5), GPT-3, GPT-3.5, GPT-4, LaMDA, PaLM, or Llama2. In particular, the structure example 3 of the information processing device is preferably capable of executing processing using GPT-4. When the structure example 3 of the information processing device can execute processing using a language model having a larger scale than a conventional natural language model, for example, text generation, interaction, or the like can be performed more naturally.

Note that a service provider using the information processing system of one embodiment of the present invention does not necessarily have its own structure example 3 of the information processing device. For example, a service provider can utilize part of the service that another company or the like provides using the structure example 3 of the information processing device.

### <<Structure Example of Network 51>>

The network 51 that can be used for the information processing system of one embodiment of the present invention can connect a plurality of information processing devices. Thus, the plurality of information processing devices connected to each other can transmit and receive data to/from each other. Furthermore, loads relating to information processing can be dispersed.

For wireless communication, it is possible to use, as a communication protocol or a communication technology, the fourth-generation mobile communication system (4G), the fifth-generation mobile communication system (5G), the sixth-generation mobile communication system (6G), or a communication standard developed by IEEE such as Wi-Fi (registered trademark) or Bluetooth (registered trademark).

For example, a local network can be used as the network 51. An intranet or an extranet can be used as the network 51. In addition, a network such as a personal area network (PAN), a local area network (LAN), a campus area network (CAN), a metropolitan area network (MAN), a wide area network (WAN), or a global area network (GAN) can be used as the network 51.

For another example, a global network can be used as the network 51. Specifically, the Internet, which is an infrastructure of the World Wide Web (WWW), can be used.

Furthermore, the service provider using the information processing system of one embodiment of the present invention can provide a service using the information processing method of one embodiment of the present invention through the network 51, for example.

Note that in the case where the information processing system of one embodiment of the present invention is constructed in a local network, the possibility of security leakage can be made lower than that in the case of using the Internet, for example.

### <<Structure Example 4 of Information Processing Device>>

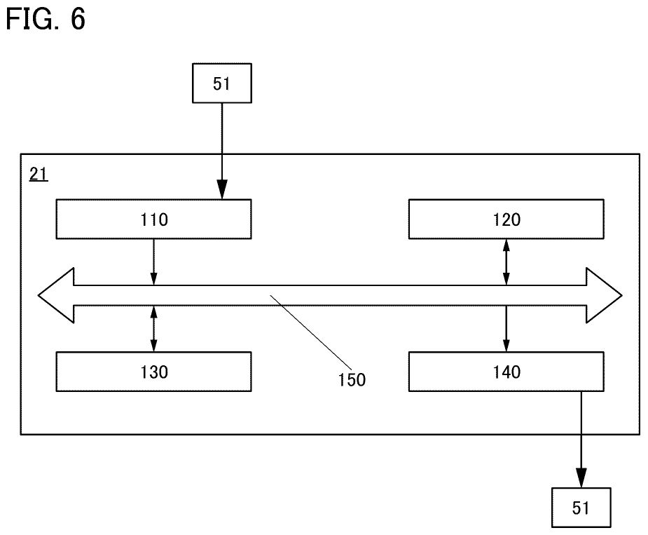

The information processing device that can be used for the information processing system of one embodiment of the present invention includes an input unit 110, a storage unit 120, a processing unit 130, an output unit 140, and a transmission path 150, for example (see FIG. 6).

Although the block diagram in drawings attached to this specification shows components classified based on their functions in independent blocks, it is difficult to classify actual components based on their functions completely, and one component can have a plurality of functions. For example, part of the processing unit 130 may function as the input unit 110. In addition, one function can be involved in a plurality of components. For example, processing executed by the processing unit 130 may be executed in different servers depending on the processing.

### [Input Unit 110]

The input unit 110 can receive data from the outside of the information processing device. For example, the input unit 110 receives data through the network 51.

The input unit 110 supplies received data to one or both of the storage unit 120 and the processing unit 130 through the transmission path 150.

### [Storage Unit 120]

The storage unit 120 has a function of storing a program to be executed by the processing unit 130. The storage unit 120 may have a function of storing data (e.g., an arithmetic result, an analysis result, and an inference result) generated by the processing unit 130, data received by the input unit 110, and the like.

The storage unit 120 may include a database. The information processing device may include another database in addition to the storage unit 120. The information processing device may have a function of extracting data from a database in the outside of the storage unit 120, in the outside of the information processing device, or in the outside of the information processing system. Alternatively, the information processing device may have a function of extracting data from both of its own database and an external database.

One or both of a storage and a file server can be used in the storage unit 120. In addition, a database in which a path of a file stored in the file server is recorded can be used for the storage unit 120.

The storage unit 120 includes at least one of a volatile memory and a nonvolatile memory. Examples of the volatile memory include a dynamic random-access memory (DRAM) and a static random-access memory (SRAM). Examples of the nonvolatile memory include a resistive random-access memory (ReRAM, also referred to as a resistance-change memory), a phase-change random-access memory (PRAM), a ferroelectric random-access memory (FeRAM), a magnetoresistive random-access memory (MRAM, also referred to as a magnetoresistive memory), and a flash memory. The storage unit 120 may include at least one of a nonvolatile oxide semiconductor random-access memory (NOSRAM, registered trademark) and a dynamic oxide semiconductor random-access memory (DOSRAM, registered trademark). The storage unit 120 may include a recording media drive. Examples of the recording media drive include a hard disk drive (HDD) and a solid-state drive (SSD).

A NOSRAM is a memory in which a memory cell is a 2-transistor (2T) or 3-transistor (3T) gain cell and a transistor using a metal oxide in a channel formation region (also referred to as an OS transistor) is used. An OS transistor has an extremely low current that flows between a source and a drain in an off state, that is, an extremely low leakage current. The NOSRAM can be used as a nonvolatile memory by retaining electric charge corresponding to data in a memory cell, using characteristics of extremely low leakage current. In particular, the NOSRAM is capable of reading retained data without destruction (non-destructive reading), and thus is suitable for arithmetic processing in which only a data reading operation is repeated many times. Since the NOSRAM stacked over another component can have large data capacity, the performance of a semiconductor device can be increased by using the NOSRAM as a large cache memory, a main memory, or a storage memory.

The DOSRAM indicates a RAM including one transistor (1T) and one capacitor (1C). The DOSRAM is a DRAM formed using an OS transistor, and a memory that temporarily stores information sent from the outside. The DOSRAM is a memory utilizing a low off-state current of the OS transistor.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium and contains any of zinc, gallium, and tin, e.g., zinc tin oxide and gallium tin oxide.

### [Processing Unit 130]

The processing unit 130 has a function of executing processing such as arithmetic processing, analysis, and inference with the use of data supplied from one or both of the input unit 110 and the storage unit 120. The processing unit 130 can supply generated data (e.g., an arithmetic result, an analysis result, or an inference result) to one or both of the storage unit 120 and the output unit 140.

The processing unit 130 has a function of obtaining data from the storage unit 120. The processing unit 130 may have a function of recording or registering data in the storage unit 120.

The processing unit 130 can include an arithmetic circuit, for example. The processing unit 130 can include, for example, a central processing unit (CPU). The processing unit 130 can include a graphics processing unit (GPU).

The processing unit 130 may include a microprocessor such as a digital signal processor (DSP). The microprocessor may be configured with a programmable logic device (PLD) such as a field programmable gate array (FPGA) or a field programmable analog array (FPAA). The processing unit 130 may include a quantum processor. The processing unit 130 can interpret and execute instructions from programs to process various kinds of data and control programs. The programs to be executed by the processor are stored in at least one of the storage unit 120 and a memory region of the processor.

The processing unit 130 may include a main memory. The main memory includes at least one of a volatile memory such as a random-access memory (RAM) and a nonvolatile memory such as a read only memory (ROM). The main memory may include at least one of the above-described NOSRAM and DOSRAM.

For example, a DRAM, an SRAM, or the like is used as the RAM, a virtual memory space is assigned and utilized as a working space of the processing unit 130. An operating system, an application program, a program module, program data, a look-up table, and the like which are stored in the storage unit 120 are loaded into the RAM for execution. The data, program, and program module which are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (Si transistor).

The processing unit 130 preferably includes an OS transistor. The OS transistor has an extremely low off-state current; therefore, with the use of the OS transistor as a switch for retaining electric charge (data) that has flowed into a capacitor functioning as a memory element, a long data retention period can be obtained. When at least one of a register and a cache memory included in the processing unit 130 has such a feature, the processing unit 130 can be operated only when needed, and otherwise can be off while data processed immediately before turning off the processing unit 130 is stored in the memory element. In other words, normally-off computing is possible and the power consumption of the information processing system can be reduced.

For at least part of the processing of the information processing device, AI is preferably used.

In particular, the information processing device preferably uses an artificial neural network (ANN; hereinafter just referred to as neural network in some cases). The neural network can be constructed with circuits (hardware) or programs (software).

In this specification and the like, the neural network indicates a general model having the capability of solving problems, which is modeled on a biological neural network and determines the connection strength of neurons by the learning. The neural network includes an input layer, a middle layer (hidden layer), and an output layer.

In the description of the neural network in this specification and the like, to determine a connection strength of neurons (also referred to as weight coefficient) from the existing information is referred to as “learning” in some cases.

In this specification and the like, to draw a new conclusion from a neural network formed with the connection strength obtained by learning is referred to as “inference” in some cases.

### [Output Unit 140]

The output unit 140 can output at least one of an arithmetic result, an analysis result, and an inference result in the processing unit 130 to the outside of the information processing device. For example, the output unit 140 can transmit data through the network 51.

### [Transmission Path 150]

The transmission path 150 has a function of transmitting data. Data transmission and reception among the input unit 110, the storage unit 120, the processing unit 130, and the output unit 140 can be performed through the transmission path 150.

Note that this embodiment can be combined with any of the other embodiments in this specification as appropriate.

### Embodiment 2

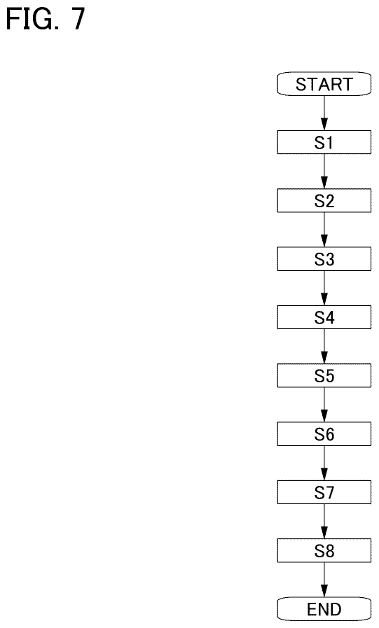

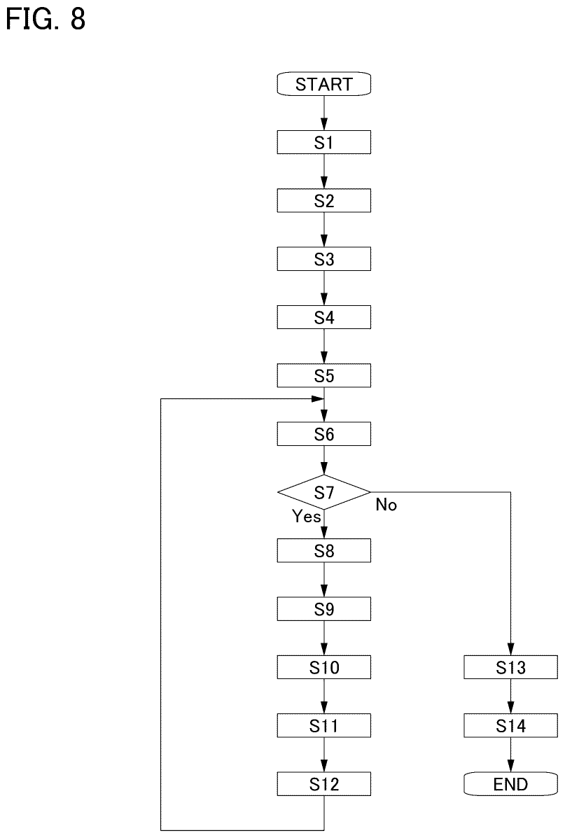

In this embodiment, an information processing method of one embodiment of the present invention will be described with reference to FIG. 7 and FIG. 8.

FIG. 7 illustrates the information processing method of one embodiment of the present invention.

FIG. 8 illustrates the information processing method of one embodiment of the present invention.

### <Example 1 of Information Processing Method>

The information processing method described in this embodiment includes Step S1 to Step S8 (see FIG. 7).

### [Step S1]

In Step S1, the component 30 receives the text TXT and the query QUE for performing retrieval in the design assets DAST and transfers the text TXT and the query QUE to the component 21.

### [Step S2]

In Step S2, the component 21 sends an inquiry to the database DB2 using the query QUE, obtains the design assets DAST, and transfers the design assets DAST to the component 30.

### [Step S3]

In Step S3, the component 21 classifies the text TXT into a predetermined class using a large language model.

### [Step S4]

When the text TXT is classified into the class CL_1, in Step S4, the component 21 specifies the class CL_1, sends an inquiry to the database DB1, and obtains the command Cmd_1, the syntax Synt_1, and the template Tmpl_1.

The database DB1 includes the record ID1_1. The record ID1_1 includes the command Cmd_1 and the syntax Synt_1, the template Tmpl_1, and the class CL_1 each associated with the command Cmd_1.

### [Step S5]

In Step S5, the component 21 generates the prompt PT_1 and transfers the prompt PT_1 to the component 20.

The prompt PT_1 includes the text TXT and the template Tmpl_1. The template Tmpl_1 includes the instruction Instr_1 for analyzing the text TXT and extracting the predetermined information INF_1, the instruction Instr_2 for converting the extracted information INF_1 into the intermediate code IntC_1 using the conversion rule CnvR_1, and the conversion rule CnvR_1.

### [Step S6]

In Step S6, in accordance with the prompt PT_1, the component 20 generates the intermediate code IntC_1 from the text TXT using a large language model and transfers the intermediate code IntC_1 to the component 21.

### [Step S7]

In Step S7, the component 21 generates the Code_1 and transfers the Code_1 to the component 30.

The Code_1 includes the command Cmd_1 using the received intermediate code IntC_1 as an argument in accordance with the syntax Synt_1.

### [Step S8]

In Step S8, the component 30 provides the Code_1 and the design assets DAST including an emphasized portion related to the Code_1.

Accordingly, the user can operate software with use of the text TXT written in a natural language. The user can operate the software even when not skilled in the operation. The user can operate the software without referring to an operation manual. The user can generate the Code_1 related to the operation with use of the text TXT written in a natural language. The user can utilize a programming language with use of the text TXT written in a natural language. The user can be provided with an emphasized portion related to the Code_1 that is retrieved from the design assets DAST of a circuit. The user can refer to the design assets DAST of the circuit. Even an inexperienced user can use a design tool made for a user with an advanced specialized knowledge. As a result, a novel information processing method that is highly convenient, useful, or reliable can be provided.

### <Example 2 of Information Processing Method>

The information processing method described in this embodiment includes Step S1 to Step S14 (see FIG. 8).

### [Step S1]

In Step S1, the component 30 receives the text TXT and the query QUE for performing retrieval in the design assets DAST and transfers the text TXT and the query QUE to the component 21.

### [Step S2]

In Step S2, the component 21 sends an inquiry to the database DB2 using the query QUE, obtains the design assets DAST, and transfers the design assets DAST to the component 30.

### [Step S3]

In Step S3, the component 21 classifies the text TXT into a predetermined class using a large language model.

### [Step S4]

When the text TXT is classified into the class CL_1, in Step S4, the component 21 specifies the class CL_1, sends an inquiry to the database DB1, and obtains the command Cmd_1, the syntax Synt_1, and the template Tmpl_1.

The database DB1 includes the record ID1_1. The record ID1_1 includes the command Cmd_1 and the syntax Synt_1, the template Tmpl_1, and the class CL_1 each associated with the command Cmd_1.

### [Step S5]

In Step S5, the component 21 generates the prompt PT_1 and transfers the prompt PT_1 to the component 20.

The prompt PT_1 includes the text TXT and the template Tmpl_1. The template Tmpl_1 includes the instruction Instr_1 for analyzing the text TXT and extracting the predetermined information INF_1; the instruction Instr_2 for converting the extracted information INF_1 into the intermediate code IntC_1 using the conversion rule CnvR_1; the conversion rule CnvR_1; and the instruction Instr_3 for generating the message MSG for requesting a supplement to the information INF_1 when the information INF_1 is not sufficiently extracted, and transferring the message MSG to the component 21.

### [Step S6]

In Step S6, in accordance with the prompt PT_1, the component 20 generates the intermediate code IntC_1 from the text TXT using a large language model and transfers the intermediate code IntC_1 to the component 21.

### [Step S7]

In Step S7, the information processing method determines to proceed to Step S8 when the information INF_1 is not sufficiently extracted, and determines to proceed to Step S13 in the other cases.

### [Step S8]

In Step S8, in accordance with the prompt PT_1, the component 20 generates the message MSG for requesting a supplement to the information INF_1 and transfers the message MSG to the component 21.

### [Step S9]

In Step S9, the component 21 transfers the message MSG to the component 30.

### [Step S10]

In Step S10, the component 30 provides the message MSG and the design assets DAST including an emphasized portion related to the command Cmd_1 and waits for input of the supplementary text SPL_1.

### [Step S11]

In Step S11, the component 30 receives the supplementary text SPL_1 and transfers the supplementary text SPL_1 to the component 21.

### [Step S12]

In Step S12, the component 21 adds the supplementary text SPL_1 to the text TXT and updates the prompt PT_1, and Step S6 is performed.

### [Step S13]

In Step S13, the component 21 generates the Code_1 and transfers the Code_1 to the component 30.

The Code_1 includes the command Cmd_1 using the received intermediate code IntC_1 as an argument in accordance with the syntax Synt_1.

### [Step S14]

In Step S14, the component 30 provides the Code_1 and the design assets DAST including an emphasized portion related to the Code_1.

Accordingly, the user can supplement and modify the text TXT with use of the supplementary text SPL_1 written in a natural language. The user can supplement and modify the operation of software. The user can supplement and modify the operation of the software even when not skilled in the operation. The user can supplement and modify the operation of the software without referring to an operation manual. The user can supplement and modify the Code_1 related to the operation with use of the supplementary text SPL_1 written in a natural language. The user can supplement and modify the description written in a programming language with use of the supplementary text SPL_1 written in a natural language. The user can be provided with an emphasized portion related to the command Cmd_1 that is retrieved from the design assets DAST of a circuit. The user can refer to the design assets DAST of the circuit. Even an inexperienced user can use a design tool made for a user with an advanced specialized knowledge. As a result, a novel information processing method that is highly convenient, useful, or reliable can be provided.

Note that this embodiment can be combined with any of the other embodiments in this specification as appropriate.

This application is based on Japanese Patent Application Serial No. 2023-188126 filed with Japan Patent Office on Nov. 2, 2023, the entire contents of which are hereby incorporated by reference.

What is claimed is:

1. An information processing system comprising:
a first component;
a second component; and
a third component,
wherein the first component is configured to receive a text written in a natural language and a query for performing retrieval in design assets and transfer the text and the query to the third component,
wherein the first component is configured to provide a code and to emphasize a portion related to the code and then provide the design assets,
wherein the second component is configured to execute processing using a large language model,
wherein the second component is configured to generate an intermediate code from the text in accordance with a prompt and transfer the intermediate code to the third component,
wherein the third component is configured to execute processing using a large language model,
wherein the third component is configured to classify the text into a predetermined class,
wherein the third component is configured to generate the prompt and transfer the prompt to the second component when the text is classified into one class,
wherein the prompt comprises the text and a template,
wherein the third component is configured to execute processing using a first database,
wherein the first database comprises a first record,
wherein the first record comprises a command, a syntax associated with the command, the template associated with the command, and the class associated with the command,
wherein the first database is configured to respond to a query for specifying the class with the command, the syntax, and the template,
wherein the third component is configured to generate the code from the command using the received intermediate code as an argument in accordance with the syntax and transfer the code to the first component,
wherein the third component is configured to execute processing using a second database,
wherein the second database is configured to respond to the query with the design assets,
wherein the third component is configured to transfer the design assets to the first component, and
wherein the template comprises:
a first instruction for analyzing the text and extracting predetermined information;
a second instruction for converting the extracted information into the intermediate code using a conversion rule; and
the conversion rule.

2. The information processing system according to claim 1,
wherein the query comprises design specifications,
wherein the second database comprises a second record, and
wherein the second record comprises the design assets and the design specifications associated with the design assets.

3. The information processing system according to claim 1,
wherein the second component is configured to generate a message for requesting a supplement to the information in accordance with the prompt and transfer the message to the third component,
wherein the third component is configured to transfer the message to the first component when receiving the message,
wherein the template comprises a third instruction for generating the message when the information is not sufficiently extracted, and
wherein the first component is configured to provide the message and to emphasize a portion related to the command and then provide the design assets when receiving the message.

4. The information processing system according to claim 2,
wherein the second component is configured to generate a message for requesting a supplement to the information in accordance with the prompt and transfer the message to the third component,
wherein the third component is configured to transfer the message to the first component when receiving the message,
wherein the template comprises a third instruction for generating the message when the information is not sufficiently extracted, and
wherein the first component is configured to provide the message and to emphasize a portion related to the command and then provide the design assets when receiving the message.

5. The information processing system according to claim 3,
wherein the first component is configured to receive a supplementary text and transfer the supplementary text to the third component, and
wherein the third component is configured to add the supplementary text to the text, update the prompt, and transfer the updated prompt to the second component.

6. The information processing system according to claim 4,
wherein the first component is configured to receive a supplementary text and transfer the supplementary text to the third component, and
wherein the third component is configured to add the supplementary text to the text, update the prompt, and transfer the updated prompt to the second component.

7. An information processing method comprising:
a first step in which a first component receives a text and a query for performing retrieval in design assets and transfers the text and the query to a second component;
a second step in which the second component sends an inquiry to a first database using the query, obtains the design assets, and transfers the design assets to the first component;
a third step in which the second component classifies the text into a predetermined class using a large language model;
a fourth step in which the second component specifies the class, sends an inquiry to a second database comprising a record, and obtains a command, a syntax, and a template,
wherein the record comprises the command, the syntax associated with the command, the template associated with the command, and the class associated with the command;
a fifth step in which the second component generates a prompt comprising the text and the template and transfers the prompt to the third component;
wherein the template comprises:
a first instruction for analyzing the text and extracting predetermined information;
a second instruction for converting the extracted information into an intermediate code using a conversion rule; and
the conversion rule,
a sixth step in which the third component generates the intermediate code from the text in accordance with the prompt using a large language model and transfers the intermediate code to the second component;
a seventh step in which the second component generates a code and transfers the code to the first component; and
an eighth step in which the first component provides the code and the design assets comprising an emphasized portion related to the code,
wherein the code comprises the command using the received intermediate code as an argument in accordance with the syntax.

8. An information processing method comprising:
a first step in which a first component receives a text and a query for performing retrieval in design assets and transfers the text and the query to a second component;
a second step in which the second component sends an inquiry to a first database using the query, obtains the design assets, and transfers the design assets to the first component;
a third step in which the second component classifies the text into a predetermined class using a large language model;
a fourth step in which the second component specifies the class, sends an inquiry to a second database comprising a record, and obtains a command, a syntax, and a template,
wherein the record comprises the command, the syntax associated with the command, the template associated with the command, and the class associated with the command;
a fifth step in which the second component generates a prompt comprising the text and the template and transfers the prompt to the third component;
wherein the template comprises:
a first instruction for analyzing the text and extracting predetermined information;
a second instruction for converting the extracted information into an intermediate code using a conversion rule;
the conversion rule; and
a third instruction for generating a message for requesting a supplement to the information when the information is not sufficiently extracted, and transferring the message to the second component,
a sixth step in which the third component generates the intermediate code from the text in accordance with the prompt using a large language model and transfers the intermediate code to the second component,
a seventh step in which the information processing method determines to proceed to an eighth step when the information is not sufficiently extracted, and determines to proceed to a thirteenth step in the other cases;
the eighth step in which the third component generates the message for requesting a supplement to the information in accordance with the prompt and transfers the message to the second component;
a ninth step in which the second component transfers the message to the first component;
a tenth step in which the first component provides the message and the design assets comprising an emphasized portion related to the command and waits for input of a supplementary text;
an eleventh step in which the first component receives the supplementary text and transfers the supplementary text to the second component;
a twelfth step in which the second component adds the supplementary text to the text and updates the prompt, and the information processing method determines to proceed to the sixth step;
the thirteenth step in which the second component generates a code and transfers the code to the first component,
wherein the code comprises the command using the received intermediate code as an argument in accordance with the syntax; and
a fourteenth step in which the first component provides the code and the design assets comprising an emphasized portion related to the code.
